(19) United States
(12) Patent Application Publication
(10) Pub. No.: US 2026/0344663 A1
(43) Pub. Date: Nov. 5, 2026

(54) HERBICIDE COMPOSITIONS

(71) Applicant: Glycoscience, S.L., Derio (ES)

(72) Inventors: Peter William Sutton, Barcelona (ES); Ángela Mourelle Insua, Derio (ES); Joana Gangoiti Muñecas, Derio (ES); Lluís Bosch Hereu, Barcelona (ES)

(21) Appl. No.: 19/697,030

(22) Filed: Jun. 3, 2026

Related U.S. Application Data
(63) Continuation of application No. PCT/IB2025/063415, filed on Dec. 23, 2025.
(60) Provisional application No. 63/740,082, filed on Dec. 30, 2024.

(51) Int. Cl. A01N 37/04; A01N 25/04; A01N 37/06; A01N 37/08; A01N 37/10; A01N 43/08; A01N 47/06; A01N 47/12; A01N 47/28; A01P 13/00

(52) U.S. Cl. CPC A01N 37/04; A01N 25/04; A01N 37/06; A01N 37/08; A01N 37/10; A01N 43/08; A01N 47/06; A01N 47/12; A01N 47/28; A01P 13/00

(57) ABSTRACT

The present disclosure relates to herbicidal compounds and compositions and their use in controlling plants or inhibiting their growth. In particular, herbicidal compounds including n0-n4 dicarboxylic monoester derivatives are provided herein. The herbicidal compositions may include solvents or additives. Methods of the present disclosure include applying the herbicidal compound to plant at preemergence and/or postemergence stages of plant growth.

### CROSS-REFERENCE TO RELATED APPLICATIONS

The present application is a continuation of PCT International Patent Application No. PCT/IB2025/063415 filed Dec. 23, 2025, which claims priority to U.S. Provisional Patent Application No. 63/740,082 filed Dec. 30, 2024, entitled “Herbicide Composition,” the entireties of which are hereby incorporated by reference.

### FIELD

The present disclosure generally relates to the field of compositions suitable for regulating plant growth and, in particular, for inhibiting plant growth.

### BACKGROUND

Synthetic herbicides and pesticides have been fundamental in enabling the agricultural revolution during the second half of the twentieth century, ensuring a plentiful supply of cheap food to an expanding population.

Unfortunately, over the decades, it has become clear that many of these compounds have unanticipated and negative human and/or environmental consequences. As a result, many have been withdrawn from the market and others are soon expected to be. In fact, a recent study found that all 230 synthetic pesticides used in the EU cause negative effects on humans or ecosystems depending on exposure levels, as disclosed in Silva et al., “Environmental and human health at risk—Scenarios to achieve the Farm to Fork 50% pesticide reduction goals,” Environ. Int., 2022, 165, 107296.

Herbicides are no exception, with the leading active substance, Glyphosate, being the subject of multiple class action lawsuits in the US in recent years, and only recently been reauthorized in the EU, following significant delays.

Increased legislation has led to no new herbicides entering the market in the past 30 years, whilst increasing weed resistance is being observed towards the old ones. Natural herbicides are perceived to be safer and enjoy more relaxed regulatory scrutiny, but most are not commercially viable.

This is not exclusive to commercial farming. Local US pesticide laws are restricting the use of synthetic pesticides and fertilizers in many residential areas. For example, in 2022, the city of Rockville, Maryland, banned the use of all synthetic pesticides from private lawns, playgrounds, mulched recreation areas, and childcare facilities to protect people, pets, and the environment. Thus, auxin-type herbicides (e.g., FLUROXYPYR), which are typically used as selective preemergence herbicides to control broadleaf weeds on lawns, can be used in progressively fewer locations.

There are surprisingly few commercially available natural herbicides, particularly given the number of natural products that display herbicidal activity. Of the few that do exist and that are available in sufficient volume, most display poor physicochemical properties (e.g., pelargonic acid, acetic acid, citric acid or eugenol) making them non-selective and expensive to use due to high application rates. Others are complex mixtures such as corn gluten meal (CGM) that, to the best of our knowledge, is the only natural selective preemergence herbicide and then, only for high value applications due to the very high application rate of 1.6 metric tons/hectare required due to the low level of active ingredient content. This is useful for the treatment of lawns, but due to its strict activity as an inhibitor of seed germination, timing of use is critical. Due to their complexity, such herbicides would be highly challenging, if not impossible, to improve rationally on a molecular level.

Thus, in spite of the different proposals for natural plant growth inhibiting compounds disclosed in the prior art, there is a need for effective compositions, in particular exhibiting pre- and/or post-emergence herbicidal activity.

### SUMMARY

An aspect of the present disclosure is the provision of a compound of Formula A:

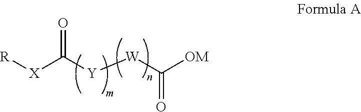

wherein:
   n is 0-4, e.g., n is 0, 1, 2, 3, or 4;
   m is 0-1, e.g., m is 0 or 1;
   X is selected from O and NH, e.g., X is O;
   when m is 1, Y is selected from O and NH, e.g., Y is O;
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, and a group selected from Table 1; and
   when n is 1 or greater, each Wis independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In certain embodiments, the compound of Formula A has herbicidal activity, e.g., preemergence, early postemergence, and/or later postemergence. In certain embodiments, the compound of Formula A is a selective herbicide having preemergence activity and early postemergence activity, but no postemergence activity. In certain embodiments, the compound of Formula A is a non-selective herbicide that has preemergence, early postemergence, and later postemergence.

In some embodiments, unstable anhydrides are not embraced by Formula A. For example, when n is 0, and m is 1, then Y cannot be O.

Another aspect of the present disclosure is the provision of a compound of Formula B:

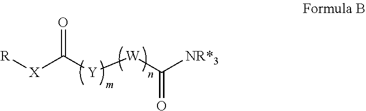

wherein:
   n is 0-4, e.g., n is 0, 1, 2, 3, or 4;
   m is 0-1, e.g., m is 0 or 1;
   each R* is independently selected from H, methyl, ethyl, or propyl, benzyl, and phenyl;
   X is selected from O and NH, e.g., X is O;
   when m is 1, Y is selected from O and NH, e.g., Y is O;
   R is selected from a monoterpenoid as provided herein, a C2-C14 hydrocarbon, and a group selected from Table 1; and
   when n is 1 or greater, each Wis independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In certain embodiments, the compound of Formula B has herbicidal activity, e.g., preemergence, early postemergence, and/or later postemergence. In certain embodiments, the compound of Formula A is a selective herbicide having preemergence activity and early postemergence activity, but no postemergence activity. In certain embodiments, the compound of Formula A is a non-selective herbicide that has preemergence, early postemergence, and later postemergence.

In some embodiments, unstable anhydrides are not embraced by Formula B. For example, when n is 0, and m is 1, then Y cannot be O.

In some embodiments of a compound of Formula A or B, the compound is characterized wherein:
n is 1 or 2;
m is 1;
X is selected from O and NH;
Y is selected from O and NH;
R is selected from a monoterpenoid as provided herein, a C2-C14 hydrocarbon, and a group selected from Table 1; and
when n is 1 or greater, each W is independently selected from CH, CH₂, CHR¹, and CR¹R², wherein
   R¹ and R² are each independently selected from a C1-C3 alkyl (e.g., methyl, ethyl, or propyl), phenyl, benzyl, phenyl, hydroxyl, and aminyl.

In some embodiments, the compound is of Formula A or B wherein:
n is 1 or 2;
m is 1;
each of X and Y is O;
R is selected from a monoterpenoid as provided herein, a C2-C14 hydrocarbon, and a group selected from Table 1; and
each W is independently selected from CH₂, CHR¹, and CR¹R², wherein
   R¹ and R² are each independently selected from a methyl, phenyl, benzyl, phenyl, hydroxyl, and aminyl.

In some embodiments, the compound is of Formula A or B wherein:
n is 1 or 2;
m is 1;
X is O or NH, e.g., NH; Y is NH;
R is selected from a monoterpenoid as provided herein, a C2-C14 hydrocarbon, and a group selected from Table 1; and
when n is 1 or greater, each Wis independently selected from CH, CH₂, CHR¹, and CR¹R², wherein
   R¹ and R² are each independently selected from a C1-C3 alkyl (e.g., methyl, ethyl, or propyl), phenyl, benzyl, phenyl, hydroxyl, and aminyl.

In some embodiments, the compound of Formula A is a compound of Formula A1:

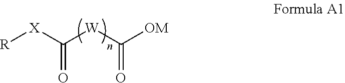

wherein:
   n is 0-4;
   X is selected from O and NH, wherein when X is O, n is 1 or greater;
   M is or a cation selected from Na⁺, K⁺, and [N(R^{a})₄]⁺, wherein each R^{a} is independently selected from H, Me and CH₂CH₂OH; preferably M is selected from H and Na⁺;
   R is selected from a monoterpenoid as provided herein, a C2-C14 hydrocarbon, and a group selected from Table 1; and
   when n is 1 or greater, each Wis independently selected from CH, CH₂, CHR¹, and CR¹R², wherein
      R¹ and R² are each independently selected from a C1-C3 alkyl (e.g., methyl, ethyl, or propyl), phenyl, benzyl, phenyl, hydroxyl, and aminyl.

In some embodiments, the compound of Formula A1 is a compound of Formula I:

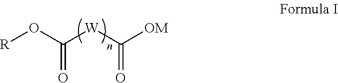

wherein:
   n is 0-4;
   M is or a cation selected from Na⁺, K⁺, and [N(R^{a})₄]⁺, wherein each R^{a} is independently selected from H, Me and CH₂CH₂OH; preferably M is selected from H and Na⁺;
   R is selected from a monoterpenoid as provided herein, a C2-C14 hydrocarbon, and a group selected from Table 1; and
   when n is 1 or greater, each W is independently selected from CH, CH₂, CHR¹, and CR¹R², wherein
      R¹ and R² are each independently selected from a C1-C3 alkyl (e.g., methyl, ethyl, or propyl), phenyl, benzyl, phenyl, hydroxyl, and aminyl.

In some embodiments, the compound of Formula A1 is a compound of Formula Ia

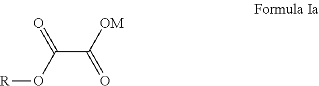

wherein:
   M is or a cation selected from Na⁺, K⁺, and [N(R^{a})₄]⁺, wherein each R^{a} is independently selected from H, Me and CH₂CH₂OH; preferably Mis selected from H and Na⁺;
   R is selected from a monoterpenoid as provided herein, a C2-C14 hydrocarbon, and a group selected from Table 1.

In some embodiments, the compound of Formula A1 is a compound of Formula Ib

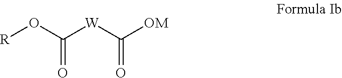

wherein:
   M is or a cation selected from Na⁺, K⁺, and [N(R^{a})₄]⁺, wherein each R^{a} is independently selected from H, Me and CH₂CH₂OH; preferably M is selected from H and Na⁺;
   R is selected from a monoterpenoid as provided herein, a C2-C14 hydrocarbon, and a group selected from Table 1; and
   W is selected from CH, CH₂, CHR¹, and CR¹R², wherein
      R¹ and R² are each independently selected from a C1-C3 alkyl (e.g., methyl, ethyl, or propyl), phenyl, benzyl, phenyl, hydroxyl, and aminyl.

In some embodiments, the compound of Formula A1 is a compound of Formula Ic

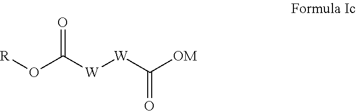

wherein:
   M is or a cation selected from Na⁺, K⁺, and [N(R^{a})₄]⁺, wherein each R^{a} is independently selected from H, Me and CH₂CH₂OH; preferably M is selected from H and Na⁺;
   R is selected from a monoterpenoid as provided herein, a C2-C14 hydrocarbon, and a group selected from Table 1; and
   when n is 1 or greater, each W is independently selected from CH, CH₂, CHR¹, and CR¹R², wherein
      R¹ and R² are each independently selected from a C1-C3 alkyl (e.g., methyl, ethyl, or propyl), phenyl, benzyl, phenyl, hydroxyl, and aminyl.

In some embodiments of the compounds provided in herein, R is a group selected from: 2-phenethyl, 1-phenethyl, L-menthyl, D-menthyl, D-(+)-para-menth-3-ol-8-yl, L-(−)-para-menth-3-ol-8-yl, D-(+)-para-menth-8-ol-3-yl, L-(−)-para-menth-8-3-yl, isopulegyl, α-terpinyl, geranyl, nonanyl, heptyl, undecanyl, and citronellyl including all isomers and stereoisomers thereof.

In some embodiments of the compounds provided in herein, e.g., a compound of Formula A, B, A1, I, Ia, Ib, Ic, the compound is selected from Table 2, including all isomers and stereoisomers thereof.

In some embodiments of the compound provided in herein, e.g., a compound of Formula A, B, A1, I, Ia, Ib, Ic, the compound is selected from menthyl succinate monoester, menthyl 2-methylsuccinate monoester, menthyl 3-methylsuccinate monoester, 2-phenethyl succinate monoester, 1-henethyl succinate monoester, geranyl 2-methylsuccinate monoester, geranyl 3-methylsuccinate monoester, geranyl succinate monoester, nonanyl succinate monoester, nonanyl 2-methylsuccinate monoester, D-menthyl succinate monoester, D-(+)-para-menth-3-ol-8-yl succinate monoester, L-(−)-para-menth-3-ol-8-yl succinate monoester, D-(+)-para-menth-8-ol-3-yl succinate monoester, L-(−)-para-menth-8-3-yl succinate monoester, isopulegyl succinate monoester, 1-phenethyl succinate monoester, alfa-terpineol succinate monoester, heptyl succinate monoester, n-undecanyl succinate monoester, citronellyl succinate monoester, geranyl oxalate monoester, geranyl malonate monoester, geranyl glutarate monoester, and isomers and stereoisomers thereof.

In some embodiments, the compound of the present disclosure, e.g., a compound of Formula A, B, A1, I, Ia, Ib, Ic, and a compound as described in Table 2, is herbicidally active, e.g., having at least one of preemergence activity, early postemergence activity, and later postemergence activity. In some embodiments, the compound exhibits selectivity towards broadleaf plants (dicots) over grasses (monocots) (i.e., the compound is more active against dicots than monocots).

In some embodiments, the compound is L-menthyl succinate monoester wherein the compound exhibits selective preemergence herbicidal activity and early postemergence herbicidal activity.

In some embodiments, the compound is selected from 1-nonanyl succinate monoester and geranyl succinate monoester, and wherein the compound exhibits non-selective preemergence and postemergence herbicidal activity.

In some embodiments, the compound is selected from L-menthyl 2-methylsuccinate monoester, 1-nonanyl 2-methylsuccinate monoester, and geranyl 2-methylsuccinate monoester.

Another aspect of the present disclosure is the provision of a composition for inhibiting plant growth comprising an effective amount of a compound according to the present disclosure, e.g., a compound of Formula A, B, A1, I, Ia, Ib, Ic, or a compound as described in Table 2.

In some embodiments, the composition is in a form selected from solution, soluble powder, emulsifiable concentrate, wettable powder, liquid flowable, dry flowable, water-dispersible granules, granules, and pellets.

In some embodiments, the composition is an emulsifiable concentrate composition. In some embodiments, the emulsifiable concentrate composition further comprises at least one surfactant, and a water immiscible solvent.

In some embodiments, the content of the effective amount of a compound according to claim 14 in the emulsifiable concentrate composition is comprised between 20 wt % and 70 wt %, preferably between 25 wt % and 65 wt %, and more preferably between 30 wt % and 60 wt %.

In some embodiments, the composition further comprises another component selected from humectants, viscosity adjusting ingredients, pH adjusting ingredients, buffers, antifreeze agents, antifoam agents, fillers, binders, dispersants, preservatives, biocides, acid scavengers, hydrotropes, densifiers, nitrogen fertilizer, storage stabilizers, or mixtures thereof.

Another aspect of the present disclosure is the provision of a method of inhibiting plant growth, the method comprising applying to the soil and/or to the plant the composition according to any one of the embodiments described herein.

These and further aspects will be further explained in the rest of the disclosure, including the Examples.

### DETAILED DESCRIPTION

The practice of the present disclosure will employ, unless otherwise indicated, conventional techniques known to those of skill in the art of developing and using herbicides,

Where a range of values is provided, it is understood that each intervening value, to the tenth of the unit of the lower limit, unless the context clearly dictates otherwise, between the upper and lower limit of that range and any other stated or intervening value in that stated range is encompassed within the disclosure. The upper and lower limits of these smaller ranges may independently be included in the smaller ranges is also encompassed within the disclosure, subject to any specifically excluded limit in the stated range. Where the stated range includes one or both of the limits, ranges excluding either or both of those included limits are also included in the disclosure.

In the following description, numerous specific details are set forth to provide a more thorough understanding of the present disclosure. However, it will be apparent to one of skill in the art that the present disclosure may be practiced without one or more of these specific details. In other instances, well-known features and procedures well known to those skilled in the art have not been described in order to avoid obscuring the disclosure.

All references cited throughout the present disclosure, including patent applications and publications, are incorporated by reference herein in their entirety.

### DEFINITIONS

As used herein, the term “cation” embraces both organic and inorganic cations known in the art. The most common organic cations used in herbicide formulations are choline, dimethylamine (DMA), and monoethanolamine (MEA). Newer, low-volatility herbicide formulations like dicamba-choline and 2,4-D-choline reduce the risk of herbicide drift and are contemplated for use with the current disclosure. For inorganic cations, those contemplated for use with the present disclosure are potassium (K⁺), sodium (Na⁺), and ammonium (NH₄⁺). Potassium salts (like potassium glyphosate) are contemplated for use in the presently disclosed formulations. Transition metals like iron (Fe²⁺) and copper (Cu²⁺) act as herbicidal active ingredients rather than as cations to form salts.

In the present description, as well as in the claims, the singular forms “a”, “an” and “the” include the plural reference unless the context clearly indicates otherwise.

The term “about” refers to a deviation of plus/minus 10% of the provided value. The percentages are expressed in % by weight (wt %), unless indicated otherwise. The ranges defined by the terms “between . . . and . . . ” or by the terms “from . . . to . . . ” are meant to include also said stated endpoints thereof, and they also include any narrower sub-range.

In the context of the present description, the term “plant growth inhibitors” means chemical substances used to inhibit the development and growth within plants, including preventing, reducing, or stopping plant growth as well as killing plants and/or plant parts.

By “comprising” it is meant that the recited elements are required in the composition/method/kit, but other elements may be included to form the composition/method/kit etc. within the scope of the claim.

By “consisting of”, it is meant the exclusion from the composition, method, or kit of any element, step, or ingredient not specified in the claim.

### Compounds

In certain embodiments, the compound of Formula A has herbicidal activity, e.g., preemergence, early postemergence, and/or later postemergence.

In certain embodiments, the compound of Formula A is a selective herbicide having preemergence activity and early postemergence activity, but no postemergence activity. In some embodiments, the compound of Formula A is a selective herbicide having postemergence activity, but no preemergence activity. In some embodiments, the compound exhibits selectivity towards broadleaf plants (dicots) over grasses (monocots) (i.e., the compound is more active against dicots than monocots). In certain embodiments, the compound of Formula A is a non-selective herbicide that has preemergence, early postemergence, and later postemergence. The terms preemergence, early postemergence, and later postemergence are known to those of skill in the art. In some embodiments, preemergence is defined as the period including seed germination until emergence from the soil or growing media. In some embodiments, early postemergence is defined as the period from emergence from the soil until (i) the plant has reached a height of 2 inches, 3 inches, or 4 inches or (ii) 4 weeks after planting, 5 weeks after planting, or 6 weeks after planting. Later postemergence encompasses the period after early preemergence. Plants in the later postemergence stage may be referred to herein as “mature.” In some embodiments, the herbicidal activity may be classified as preemergence (before emergence from the soil) and postemergence (after emergence from the soil).

An aspect of the present disclosure is the provision of compounds of Formula A:

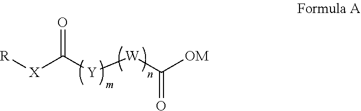

wherein:
   n is 0-4, e.g., n is 0, 1, 2, 3, or 4;
   m is 0-1, e.g., m is 0 or 1;
   X is selected from O and NH, e.g., X is O;
   Y is selected from O and NH, e.g., Y is O;
   R is selected from a monoterpenoid as provided herein, a C2-C14 hydrocarbon, a group selected from Table 1; and
   when n is 1 or greater, each Wis independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In some embodiments, unstable anhydrides are not embraced by Formula A. For example, when n is 0, and m is 1, then Y cannot be O.

In some embodiments, R is a monoterpenoid wherein X is not bonded directly to an aromatic carbon.

A second aspect of the present disclosure is the provision of compounds of Formula B:

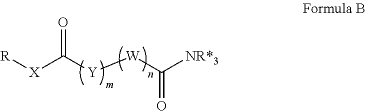

wherein:
   n is 0-4, e.g., n is 0, 1, 2, 3, or 4;
   m is 0-1, e.g., m is 0 or 1;
   each R* is independently selected from C1-C3 alkyl (e.g., methyl, ethyl, or propyl)benzyl, and phenyl,
   X is selected from O and NH, e.g., X is O;
   when m is 1, Y is selected from O and NH, e.g., Y is O;
   R is selected from a monoterpenoid as provided herein, a C2-C14 hydrocarbon, a group selected from Table 1; and
   when n is 1 or greater, each W is independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In some embodiments, the compound of Formula A or B is characterized wherein: n is 1 or 2; m is 1; X is O or NH; Y is NH.

In some embodiments, the compound of the present disclosure is according to Formula A1:

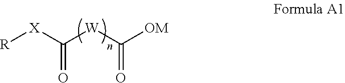

wherein:
   n is 0-4;
   X is selected from O and NH, wherein when X is O, n is 1 or greater;
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1; and
   when n is 1 or greater, each Wis independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In some embodiments, the compound of Formula A1 is characterized wherein: n is 1 or 2; m is 1; X is O, M is H or a cation; R is selected from the group listed in Table 1; and each W is independently selected from CH, CH₂, CHR¹, and CR¹R², wherein R¹ and R² are each independently selected from a C1-C3 alkyl (e.g., methyl, ethyl, or propyl), benzyl, phenyl, hydroxyl, and aminyl.

### Formula I

An aspect of the present disclosure is the provision of compounds formed by the reaction of a class of R—OH compounds descried herein with derivatives of oxalic acid, malonic acid, succinic acid, glutaric acid, or adipic acid (precursor to Formula I) to form compounds of Formula I. In certain embodiments, the precursor to Formula I is selected from: succinic acid, 2-methylsuccinic acid, 2-phenylsuccinic acid, 2,2-dimethylsuccinic acid, 2,3-dimethylsuccinic acid, 2,2-diphenylsuccinic acid, and 2-methyl-2-phenylsuccinic acid, preferably selected from succinic acid and 2-methylsuccinic acid.

In certain embodiments, the R—OH compound is selected from a class of natural compounds known as a monoterpenoid, as described herein.

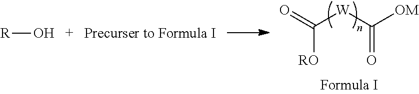

In some embodiments, the compound of the present disclosure is according to Formula I:

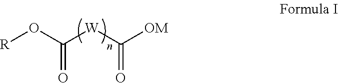

wherein:
   n is 0-4, e.g., 0, 1, 2, 3, or 4;
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1; and
   when n is 1 or greater, each W is independently selected from CH, CH₂, CHR¹, and CR¹R², wherein
   R¹ and R² are each independently selected from a C1-C3 alkyl (e.g., methyl, ethyl, or propyl), benzyl, phenyl, hydroxyl, and aminyl.

In some embodiments, the compound of the present disclosure is according to Formula Ia:

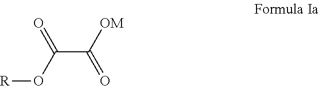

wherein:
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1.

In some embodiments, the compound of the present disclosure is according to Formula Ib

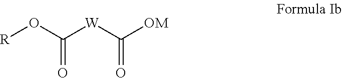

wherein:
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1; and
   W is selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In some embodiments, the compound of the present disclosure is according to Formula Ic

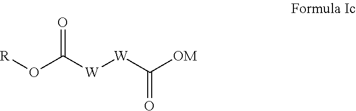

wherein:
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1; and
   each W is independently selected from CH, CH₂, CHR¹, and CR¹R², wherein
      R¹ and R² are each independently selected from a C1-C3 alkyl (e.g., methyl, ethyl, or propyl), benzyl, phenyl, hydroxyl, and aminyl.

In some embodiments, the compound of the present disclosure is according to Formula Ic′:

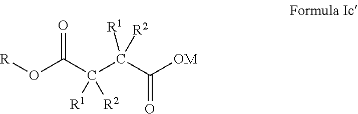

wherein:
   M is H or a cation, e.g., Na⁺, K⁺, [N(R^{a})₄]⁺, wherein R^{a} is independently selected from H, Me and CH₂CH₂OH; preferably M is selected from H and Na⁺;
   R is selected from a monoterpenoid as provided herein, a C2-C14 hydrocarbon, a group selected from Table 1; and
   each R¹ and R² are independently selected from a C1-C3 alkyl (e.g., methyl, ethyl, or propyl), benzyl, phenyl, hydroxyl, and aminyl.

### R Groups of the Present Disclosure

In some embodiments of the provided compounds, R is derived from R—OH, wherein R—OH is a C10 monoterpenoid compound (i.e., mono or polyhydroxylated monoterpene compound). These compounds are found abundantly in nature and play essential roles in the biochemistry of plants, animals, and microorganisms.

In some embodiments, the hydroxy moiety of a C10 monoterpenoid compound suitable for use with the present disclosure may be a primary, secondary, or tertiary alcohol and wherein the monoterpenoid hydroxyl group is not bonded to an aromatic carbon, i.e., the hydroxy is non-phenolic. Exemplary monoterpenoids for use with the present disclosure include but are not limited to: para-menthane-3,8-diol (PMD), menthol, linalool, geraniol, citronellol, terpineol, perillyl alcohol, borneol, isopulegol, α-terpineol, along with each of their corresponding stereoisomers, including diastereomers, racemates, and enantiomers thereof.

TABLE 1
Example R groups

| Structure # | Structure |
|---|---|
| 1 | 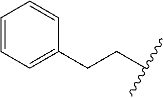 [SMILES: *CCc1ccccc1] |
| 2 | 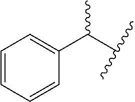 [SMILES: *C(C)c1ccccc1] |
| 3 | 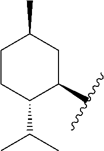 [SMILES: *[C@@H]1C[C@H](C)CC[C@H]1C(C)C] |
| 4 | 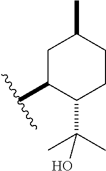 [SMILES: *[C@H]1C[C@@H](C)CC[C@@H]1C(C)(C)O] |
| 5 | 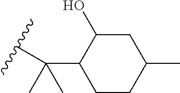 [SMILES: *C(C)(C)C1CCC(C)CC1O] |
| 6 | 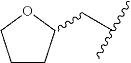 [SMILES: *CC1CCCO1] |
| 7 | 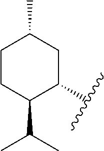 [SMILES: *[C@H]1C[C@@H](C)CC[C@@H]1C(C)C] |
| 8 | 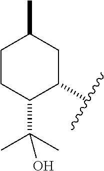 [SMILES: *[C@H]1C[C@H](C)CC[C@H]1C(C)(C)O] |
| 9 | 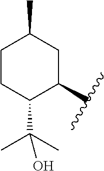 [SMILES: *[C@@H]1C[C@H](C)CC[C@H]1C(C)(C)O] |
| 10 | 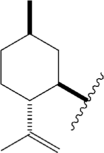 [SMILES: *[C@@H]1C[C@H](C)CC[C@H]1C(=C)C] |
| 11 | 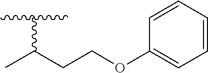 |
| 12 | 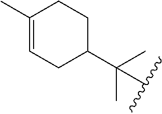 [SMILES: *C(C)(C)C1CC=C(C)CC1] |
| 13 | 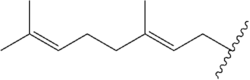 [SMILES: *C/C=C(\C)CCC=C(C)C] |
| 14 | 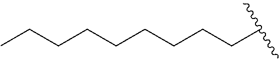 [SMILES: *CCCCCCCCC] |
| 15 | 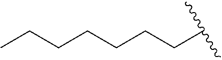 [SMILES: *CCCCCCC] |
| 16 | 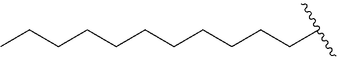 [SMILES: *CCCCCCCCCCC] |
| 17 | 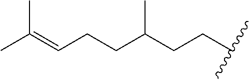 [SMILES: *CCC(C)CCC=C(C)C] |
| 18 | 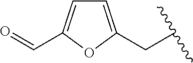 [SMILES: *Cc1ccc(C=O)o1] |

Each stereoisomer of an R group having a chiral carbon identified in Table 1 is also contemplated according to the present disclosure. For example, the structure of D-(+)-menthyl also inherently embraces the other known stereoisomers: D-(+)-menthyl, L-(−)-menthyl, D-(+)-neomenthyl, L-(−)-neomenthyl, D-(+)-isomenthyl, L-(−)-isomenthyl, D-(+)-neoisomenthyl, and L-(−)-neoisomenthyl, as would be understood by one of skill in the art.

In some embodiments of the compound according to Formula A, B, A1, I, Ia, Ib, or Ic, R is a monoterpenoid selected from: L-menthyl, D-menthyl, isopulegyl, α-terpinyl, geranyl, citronellyl, para-menth-3-ol-8-yl (PMD-8-yl), para-menth-8-ol-3-yl (PMD-3-yl), linalyl, perillyl, and bornyl, including the stereoisomers thereof, e.g.: D-(+)-para-menth-3-ol-8-yl, L-(−)-para-menth-3-ol-8-yl, D-(+)-para-menth-8-ol-3-yl, L-(−)-para-menth-8-ol-3-yl, D-(+)-linalyl, L-(−)-linalyl, D-(+)-geranyl, L-(−)-geranyl, D-(+)-citronellyl, L-(−)-citronellyl, D-(+)-terpinyl, L-(−)-terpinyl, D-(+)-perillyl, L-(−)-perillyl, D-(+)-isopulegyl, L-(−)-isopulegyl, D-(+)-α-terpinyl, and L-(−)-α-terpinyl.

In some embodiments of the compound according to Formula A, B, A1, I, Ia, Ib, or Ic, R is a C2-C14 hydrocarbon, e.g., an alkyl or alkenyl group that may be straight chain, branched, or cyclic. In some embodiments, R is a C3-C12 hydrocarbon. In some embodiments, R is a C4-C10 hydrocarbon. In some embodiments, R is a C5-C10 hydrocarbon. In some embodiments, R is an unsubstituted C2-C12 hydrocarbon that consists of carbon and hydrogen atoms.

In some embodiments, R is a cyclic C6-C12 hydrocarbon. In some embodiments, the cyclic C6-C12 hydrocarbon is aromatic. In some embodiments, the cyclic C6-C12 hydrocarbon is non-aromatic. In some embodiments, the cyclic C6-C12 hydrocarbon includes a hetero atom in its ring. In some embodiments, the cyclic C6-C12 hydrocarbon does not include a hetero atom. In some embodiments, the cyclic C6-C12 hydrocarbon is substituted. In some embodiments, the cyclic C6-C12 hydrocarbon is unsubstituted and consists of carbon and hydrogen atoms.

In some embodiments, the C2-C14 hydrocarbon is selected from linear alkyl groups including methyl (—CH₃) for C₁, ethyl (—CH₂CH₃) for C₂, propyl (—CH₂CH₂CH₃) for C₃, butyl (—CH₂CH₂CH₂CH₃) for C₄, pentyl (—CH₂(CH₂)₃CH₃) for C₅, hexyl (—CH₂(CH₂)₄CH₃) for C₆, heptyl (—CH₂(CH₂)₅CH₃) for C₇, octyl (—CH₂(CH₂)₆CH₃) for C₈, nonyl (—CH₂(CH₂)₇CH₃) for C₉, and decyl (—CH₂(CH₂)₈CH₃) for C₁₀. Branched alkyl groups include isopropyl (—CH(CH₃)₂), sec-butyl (—CH₃CHCH₂CH₃), tert-butyl (—C(CH₃)₃), isopentyl (—CH₂CH₂CH(CH₃)₂), and neopentyl (—CH₂C(CH₃)₃).

In some embodiments the C₂-C₁₄ hydrocarbon is selected from alkenyl including ethenyl (—CH—CH₂) for C₂, propenyl (—CH₂CH═CH₂) for C₃, butenyl (—CH₂CH₂CH═CH₂) for C₄, pentenyl (—CH₂(CH₂)₂CH═CH₂) for C₅, hexenyl (—CH₂(CH₂)₃CH═CH₂) for C₆, heptenyl (—CH₂(CH₂)₄CH═CH₂) for C₇, octenyl (—CH₂(CH₂)₅CH═CH₂) for C₈, nonenyl (—CH₂(CH₂)₆CH═CH₂) for C₉, and decenyl (—CH₂(CH₂)₇CH═CH₂) for C₁₀. Branched alkenyl groups include allyl (—CH₂CH═CH₂) for C₃, isopentenyl (—CH₂C(CH₃)═CH₂) for C₅, and geranyl (—CH₂CH₂C(CH₃)═CHCH₂CH═CH₂) for C₁₀. Additionally, alkenyl groups exhibit cis-trans isomerism, where cis- and trans-pentenyl, for example, differ in the relative positions of substituents across the double bond.

In some embodiments, the C₂-C₁₄ hydrocarbon is selected from aryl-alkyl groups including those featuring a benzene ring attached to a short carbon chain such as benzyl (C₆H₅CH₂—), phenylpropyl (C₆H₅CH₂CH₂—), methylbenzyl (C₆H₄CH₃—, also known as tolyl), ethylbenzyl (C₆H₄CH₂CH₃—), 1-naphthylmethyl (C₁₀H₇CH₂—), 2-naphthylmethyl (C₁₀H₆CH₂—), biphenylmethyl (C₆H₅C₆H₄CH₂—), benzhydryl (C₆H₅CH(C₆H₅)—), diphenylmethyl (CH(C₆H₅)₂—), styryl (C₆H₅CH═CH—), benzoylmethyl (C₆H₅COCH₂—), and phenylisopropyl (C₆H₅CH(CH₃)₂—). Regioisomers of these are also contemplated.

In some embodiments the C₂-C₁₄ hydrocarbon is selected from 2-phenethyl, 1-phenethyl, heptyl, undecanyl, and nonanyl.

In some embodiments, the C2-C14 hydrocarbon is a phenolic compound, such as a naturally occurring C6-C14 phenolic compound. For example, the phenolic compound may be selected from phenols, phenolic acids, phenolic aldehydes, acetophenones, tyrosine derivatives, phenylacetic acids, hydroxycinnamic acids, allylbenzenes, coumarins, isocoumarins, chromones, naphthoquinones, xanthanoids, stilbenoids, or anthraquinones. Non-limiting examples include phenol (C6H6O), xylenol (C8H10O), eugenol (C10H12O2), thymol (C10H14O), carvacrol (C10H14O), and the like.

In some embodiments of the compound according to Formula A, B, A1, I, Ia, Ib, or Ic, R is selected from the group consisting of: 2-phenethyl, 1-phenethyl, L-menthyl, D-menthyl, D-(+)-para-menth-3-yl, L-(−)-para-menth-3-yl, isopulegyl, α-terpinyl, geranyl, nonanyl, heptyl, undecanyl, and citronellyl.

In some embodiments of the compound according to Formula A, B, A1, I, Ia, Ib, or Ic, the compound is selected from the group listed in Table 2.

TABLE 2

| Compound | |
|---|---|
| # | Structure |
| 101 | 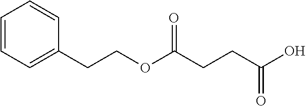 [SMILES: O=C(O)CCC(=O)OCCc1ccccc1] |
| 102 | 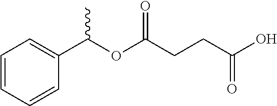 [SMILES: CC(OC(=O)CCC(=O)O)c1ccccc1] |
| 103a | 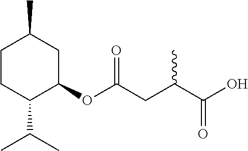 [SMILES: CC(CC(=O)O[C@@H]1C[C@H](C)CC[C@H]1C(C)C)C(=O)O] |
| 103b | 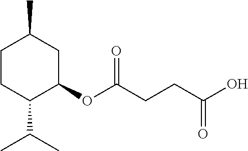 [SMILES: CC(C)[C@@H]1CC[C@@H](C)C[C@H]1OC(=O)CCC(=O)O] |
| 105 | 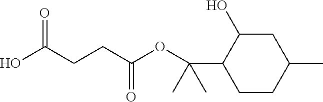 [SMILES: CC1CCC(C(C)(C)OC(=O)CCC(=O)O)C(O)C1] |
| 107 | 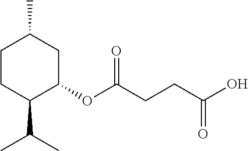 [SMILES: CC(C)[C@H]1CC[C@H](C)C[C@@H]1OC(=O)CCC(=O)O] |
| 109 | 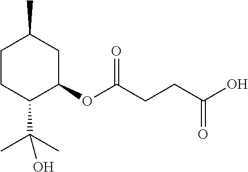 [SMILES: C[C@@H]1CC[C@@H](C(C)(C)O)[C@H](OC(=O)CCC(=O)O)C1] |
| 110 | 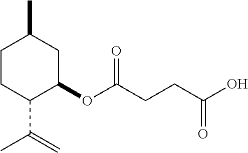 [SMILES: C=C(C)[C@@H]1CC[C@@H](C)C[C@H]1OC(=O)CCC(=O)O] |
| 111 | 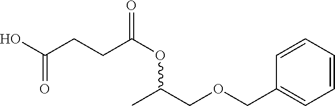 [SMILES: CC(COCc1ccccc1)OC(=O)CCC(=O)O] |
| 112 | 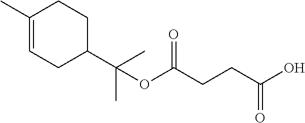 [SMILES: CC1=CCC(C(C)(C)OC(=O)CCC(=O)O)CC1] |
| 113a | 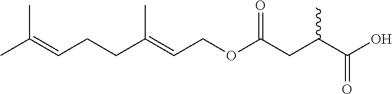 [SMILES: CC(C)=CCC/C(C)=C/COC(=O)CC(C)C(=O)O] |
| 113b | 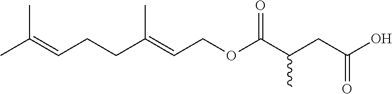 [SMILES: CC(C)=CCC/C(C)=C/COC(=O)C(C)CC(=O)O] |
| 113c | 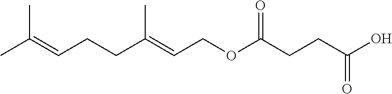 [SMILES: CC(C)=CCC/C(C)=C/COC(=O)CCC(=O)O] |
| 113d | 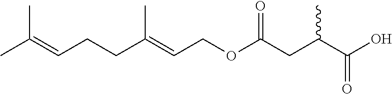 [SMILES: CC(C)=CCC/C(C)=C/COC(=O)CC(C)C(=O)O] |
| 113e | 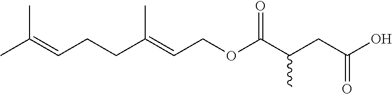 [SMILES: CC(C)=CCC/C(C)=C/COC(=O)C(C)CC(=O)O] |
| 113f | 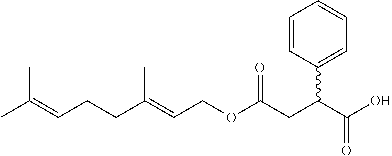 [SMILES: CC(C)=CCC/C(C)=C/COC(=O)CC(C(=O)O)c1ccccc1] |
| 113g | 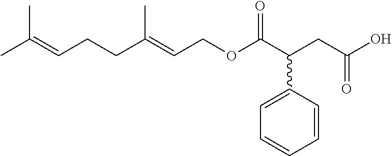 [SMILES: CC(C)=CCC/C(C)=C/COC(=O)C(CC(=O)O)c1ccccc1] |
| 113h | 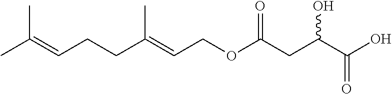 [SMILES: CC(C)=CCC/C(C)=C/COC(=O)CC(O)C(=O)O] |
| 113i | 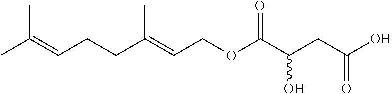 [SMILES: CC(C)=CCC/C(C)=C/COC(=O)C(O)CC(=O)O] |
| 113j | 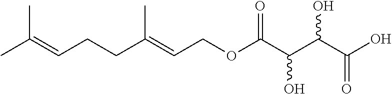 [SMILES: CC(C)=CCC/C(C)=C/COC(=O)C(O)C(O)C(=O)O] |
| 113k | 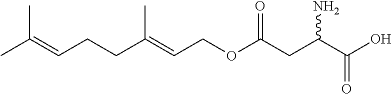 [SMILES: CC(C)=CCC/C(C)=C/COC(=O)CC(N)C(=O)O] |
| 113l | 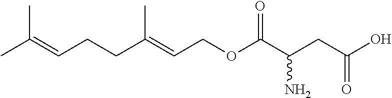 [SMILES: CC(C)=CCC/C(C)=C/COC(=O)C(N)CC(=O)O] |
| 113m | 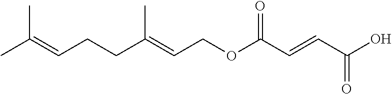 [SMILES: CC(C)=CCC/C(C)=C/COC(=O)/C=C/C(=O)O] |
| 113n | 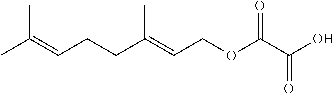 [SMILES: CC(C)=CCC/C(C)=C/COC(=O)C(=O)O] |
| 113o | 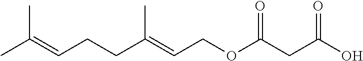 [SMILES: CC(C)=CCC/C(C)=C/COC(=O)CC(=O)O] |
| 113p | 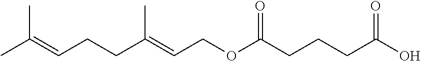 [SMILES: CC(C)=CCC/C(C)=C/COC(=O)CCCC(=O)O] |
| 113q | 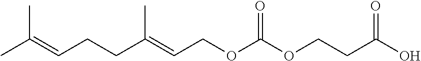 [SMILES: CC(C)=CCC/C(C)=C/COC(=O)OCCC(=O)O] |
| 113r | 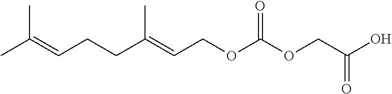 [SMILES: CC(C)=CCC/C(C)=C/COC(=O)OCC(=O)O] |
| 113s | 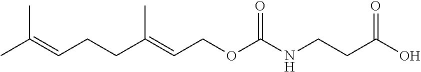 [SMILES: CC(C)=CCC/C(C)=C/COC(=O)NCCC(=O)O] |
| 113t | 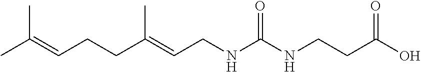 [SMILES: CC(C)=CCC/C(C)=C/CNC(=O)NCCC(=O)O] |
| 113u | 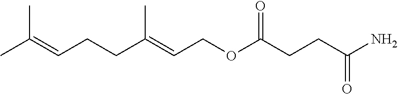 [SMILES: CC(C)=CCC/C(C)=C/COC(=O)CCC(N)=O] |
| 114a | 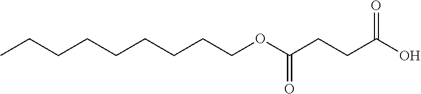 [SMILES: CCCCCCCCCOC(=O)CCC(=O)O] |
| 114b | 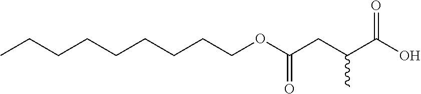 [SMILES: CCCCCCCCCOC(=O)CC(C)C(=O)O] |
| 115 | 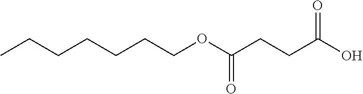 |
| 116 | 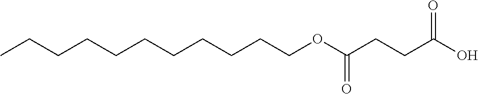 [SMILES: CCCCCCCCCCCOC(=O)CCC(=O)O] |
| 117 | 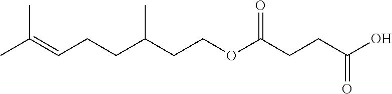 [SMILES: CC(C)=CCCC(C)CCOC(=O)CCC(=O)O] |
| 118 | 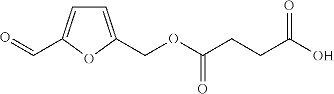 [SMILES: O=Cc1ccc(COC(=O)CCC(=O)O)o1] |

Those compounds of Table 2 depicted with a squiggle line are meant to embrace both stereoisomeric forms generated from the chiral center. The dashed and bold straight lines represent relative stereochemistry that embrace an enantiomeric pair. Also, the dashed and bold wedged lines represent absolute stereochemistry and represent a single enantiomer.

In embodiments of a compound according to Formula A, B, A1, I, Ia, Ib, or Ic, the compound is selected from the group consisting of: menthyl succinate (e.g., L or D), menthyl 2-methylsuccinate (e.g., L or D), 2-phenethyl succinate, 3-phenethyl succinate, 1-phenethyl succinate monoester, geranyl 2-methylsuccinate monoester, geranyl 3-methylsuccinate monoester, geranyl succinate, nonanyl succinate, nonanyl 2-methylsuccinate monoester, nonanyl 3-methylsuccinate monoester, menthyl succinate monoester (L and D), D-(+)-para-menth-3-yl succinate monoester, L-(−)-para-menth-3-yl succinate monoester, isopulegyl succinate monoester, 1-phenethyl succinate monoester, alfa-terpinyl succinate monoester, heptyl succinate monoester, e.g., n-heptyl succinate monoester, undecanyl succinate monoester, e.g., n-undecanyl succinate monoester, citronellyl succinate monoester, geranyl oxalate monoester, geranyl malonate monoester, geranyl glutarate monoester, and mixtures thereof.

In embodiments comprising a chiral compound, the present disclosure contemplates all enantiomeric forms when no particular isomer is identified specifically. For example, menthyl succinate monoester inherently embraces all 8 stereo-isomers that would be known to one of skill in the art, comprising 4 enantiomeric pairs: D-(+)-menthyl succinate, L-(−)-menthyl succinate, D-(+)-neomenthyl succinate, L-(−)-neomenthyl succinate, D-(+)-isomenthyl succinate, L-(−)-isomenthyl succinate, D-(+)-neoisomenthyl succinate, L-(−)-neoisomenthyl succinate.

### Herbicidally Active Compounds

In embodiments of the present disclosure, a compound of Formula A, B, A1, I, Ia, Ib, Ic as provided herein, including a compound as described in Table 2 and those described above, is characterized as herbicidally active, e.g., having at least one of preemergence activity, early postemergence activity, and later postemergence activity. In some embodiments, the compounds have reduced volatility, e.g., compared to pelargonic acid.

### Herbicidally Active Compositions

An aspect of the present disclosure relates to the provision of a composition for inhibiting plant growth comprising an effective amount of at least one herbicidally active ingredient according to the present disclosure, e.g., a compound of Formula A, B, A1, I, Ia, Ib, Ic or a compound as described in Table 2, including all the known stereoisomers. In some embodiments, the compound is chiral. In certain embodiments, the chiral compound is present in the composition as a racemic mixture or wherein the composition is enantiomerically enriched in one of the enantiomers.

In some embodiments, the provided composition comprising an herbicidally active ingredient according to the present disclosure further comprises solvents and/or surfactants known in the art to form a composition comprising the herbicide active ingredient in a suitable concentration. In some embodiments, the compound of Formula A, B, A1, I, Ia, Ib, Ic or a compound as described in Table 2 is the only herbicidally active ingredient in the composition.

The provided composition allows the user to dispense the composition in a convenient solvent/carrier, such as water. The primary purpose of the solvent/carrier is to enable the uniform distribution of a relatively small amount of herbicide over a comparatively large area.

The combination of the herbicide active ingredient with a proper carrier, surfactants and/or adjuvants provides the consumer with a form of herbicide that is easy to handle, that may enhance the phytotoxicity of the herbicide, improve the shelf-life during storage, and protect the herbicide from adverse environmental conditions while in storage or transit.

An adjuvant is any material that is added to an herbicide solution to enhance or modify the performance of the composition.

A given herbicide active ingredient may be formulated in a variety of differing compositions: solution, soluble powder, emulsifiable concentrate, wettable powder, liquid flowable, dry flowable, water-dispersible granules, granules, or pellets.

A solution composition is designed for those active ingredients that dissolve readily in water. The formulation is a liquid and consists of the active ingredient and additives. To apply the composition, it is usually mixed with water.

A soluble powder composition is similar to solution in that, when mixed with water, these dry formulations dissolve readily and form a true solution. The formulation is dry and consists of the active ingredient and additives.

An emulsifiable concentrate composition is a liquid composition comprising an herbicidal active ingredient, at least one surfactant that acts as an emulsifying agent, and a water immiscible solvent. Upon dilution, said concentrates generally form oil-in-water (O/W) emulsions. The oil component in the resulting (O/W) emulsion comprises the herbicidal active ingredient.

A wettable powder composition is a dry, finely ground formulation in which the active ingredient is combined with a finely ground carrier (usually mineral clay) along with other ingredients, to enhance the ability of the active ingredient plus carrier to suspend in water. The powder is mixed with water for application.

A liquid flowable composition consists of finely ground active ingredient suspended in a liquid, which is further mixed with water for application.

A dry flowable and water-dispersible granule composition is similar to a wettable powder except that the active ingredient is formulated on a large particle (granule) instead of onto a ground powder.

Granules and pellets are used exclusively for soil-applied herbicides, wherein the active ingredient is formulated onto large particles (granules or pellets).

In an embodiment, the herbicide composition is an emulsifiable concentrate composition. The content of the herbicidal active ingredient in the emulsifiable concentrate composition is usually comprised between 20 wt % and 70 wt %, between 25 wt % and 65 wt %, or between 30 wt % and 60 wt %.

The content of the surfactant present in the herbicide composition of the disclosure may be comprised between 2 wt % to 25 wt %, between 5 wt % and 20 wt %, or between 7 wt % and 15 wt %. The skilled person may adjust the content of surfactant depending on whether the surfactant is added as a substantive or auxiliary agent, in accordance with standard practice.

An emulsifiable concentrate composition may use aromatic hydrocarbons as well as non-aromatic compounds as water immiscible solvent. Aromatic hydrocarbons may be benzene, benzonitrile, benzyl alcohol, chlorobenzene, fluorobenzene, pyridine, tetralin, toluene, trifluorotoluene, xylenes, and mixtures thereof. Non-aromatic hydrocarbons are: dimethyl carbonate, cyclohexanone, butanone, ethyl acetate, diethyl carbonate, n-butyl carbonate, d-limonene, 2-methyltetrahydrofuran, propylene carbonate, and mixtures thereof. The water immiscible solvent may be selected from non-aromatic compounds.

In an embodiment, the herbicidal concentrate composition may be non-aqueous. The term “non-aqueous” means that substantially no water is included in the composition. The concentration of water is no more than about 5 wt %, no more than about 2 wt %, no more than about 1 wt %, preferably no more than about 0.1 wt %, or no more than about 0.01 wt %.

In an embodiment, the herbicide composition is the result of diluting the emulsifiable concentrated composition with water (e.g., hard water, soft water, etc.), to obtain an application mixture containing a relatively dilute concentration of the herbicide active ingredient, in the form of a stable (O/W) emulsion that is ready for use. In an embodiment, the concentration of the herbicide active ingredient in these mixtures may be no more than about 2 wt %, no more than about 1 wt %, or no more than about 0.5 wt %.

In an embodiment, the surfactant present in the emulsifiable concentrate composition is selected from anionic, non-ionic, and mixtures thereof.

The anionic surfactant may be selected, for example, from alkyl sulfates, alcohol sulfates, alcohol ether sulfates, alpha olefin sulfonates, alkylaryl ether sulfates, arylsulfonates, alkylsulfonates, alkylaryl sulfonates, sulfosuccinates, mono- or diphosphate esters of alkyl alcohols, polyalkoxylated alkyl alcohols, alkyl phenols, or polyalkoxylated alkyl phenols, mono- or disulfosuccinate esters of alcohols or polyalkoxylated alkanols, mono sulfosuccinates of fatty acid alkanolamides, alkyl sulfosuccinamates, alcohol ether carboxylates, phenol ether carboxylates, petroleum sulfonates, fatty acid isethionates, acyl sarcosinates, taurides, soaps, and mixtures thereof.

Specific anionic surfactants are well known to those in the art and are commercially available from companies such as BASF, Kao, Croda, and Akzo Nobel.

The non-ionic surfactant may be selected, for example, from alkyl polyglucosides, alkoxylated fatty oils, sorbitan esters, ethoxylated sorbitan esters, alkoxylated alkylphenols, alkoxylated alcohols, polyalkylene oxide block copolymers, ethoxylated/propoxylated fatty alcohols, capped ethoxylated fatty alcohols, alkoxylated alkanolamides, alkoxylated alkylamines, fatty acid alkanolamides, glyceryl fatty acids esters, lanolin derivatives, sucrose esters, alkoxylated fatty acids, and mixtures thereof.

Specific non-ionic surfactants from these types are commercially available from companies such as BASF, Kao, Croda, and Akzo Nobel.

In an embodiment, the non-ionic surfactant component comprises at least one non-ionic surfactant having a hydrophilic-lipophilic balance (HLB) value comprised between 5 to 20 or between 7 and 16. It is well-known in the art, that a combination of non-ionic surfactants having a wide range of HLB values can provide for greater stability when the composition is formulated as an emulsifiable concentrate, and provides (O/W) emulsions with improved stability when diluted with water. For example, the non-ionic surfactant component may comprise a combination of surfactants having an HLB value from about 5 to about 9, an HLB value from about 12 to about 15, and an HLB value from about 15 to about 17.

The presence of a surfactant in the herbicide composition provides stability of the liquid and enhancement of biologic activity. The first feature, stability, is accomplished both before and after dilution of the concentrate with water and must last long enough to spray the herbicide. In solvent-based formulations, a surfactant permits a stable (O/W) emulsion to form when diluted with water. The composition may include both a primarily water-soluble surfactant and an oil soluble one to maximize the emulsion droplet stabilization.

The enhancement of biologic activity of the herbicide active ingredient by the presence of a surfactant in the composition is based on the improvement of the spreading of the spray droplets deposited on the leaf to maximize surface area contact.

Other adjuvants may be included in the formulations of the disclosure. In an embodiment, the composition further comprises another component selected from humectants, viscosity adjusting ingredients, pH adjusting ingredients, buffers, antifreeze agents, antifoam agents, fillers, binders, dispersants, preservatives, biocides, acid scavengers, hydrotropes, densifiers, nitrogen fertilizer, storage stabilizers, or mixtures thereof. Humectants include, for example, polyols. Viscosity adjusting agents include, for example, glycols. pH adjusting ingredients include, for example, buffers, inorganic acids (e.g., sulfuric acid, phosphoric acid), and inorganic hydroxides (e.g., sodium hydroxide, potassium hydroxide). Buffers to maintain a stable pH, such as, for example, sodium acetate, sodium citrate, and alkali salts of phosphoric acid. Antifreeze agents to allow stability at low temperatures, include alcohols such as, for example, ethylene glycol, propylene glycol, butanediol, pentanediol, mannitol, sorbitol, and glycerol. Antifoam agents include organosilicone or silicone-free compounds. Fillers, also known as carriers, are, for example, clay, kaolin, talc, pumice, bentonite, attapulgite, silica, magnesium oxide, diatomaceous earth, and mixtures thereof. Binders are necessary in the manufacturing process of water-dispersible granules, and are, for example, polyvinylpyrrolidone. Dispersants stabilize suspended particles after dilution, and are, for example, lignin sulfonates, naphthalene formaldehyde condensates, and mixtures thereof. Preservatives and biocides to prevent mold, fungal, and bacterial growth, such as, for example, isothiazolones, parabens, propionic acid, sodium sulfite, sorbic acid, and mixtures thereof. Acid scavengers to prevent oxidation of unsaturated bonds, such as, for example, epoxidized soyabean oil. Hydrotropes to increase water solubility of low-water soluble compounds, such as, for example, sodium xylene sulfonate, isoamyl alcohol, and mixtures thereof. Densifiers such as, for example, sodium chloride, aluminum sulfate, and mixtures thereof. Nitrogen fertilizer to enhance herbicidal effectiveness by stimulating active metabolism and growth, such as, for example, urea, ammonium nitrate, and mixtures thereof. Storage stabilizers are substituted or unsubstituted pyrrolidone compounds, such as, for example, N-methyl-2-pyrrolidone, N-butyl-2-pyrrolidone, and mixtures thereof.

In an embodiment, the herbicide composition is the result of diluting the concentrated composition with water (e.g., hard water, soft water, etc.), to obtain an application mixture containing a relatively dilute concentration of the herbicide active ingredient, in the form of a stable (O/W) emulsion that is ready for use. In an embodiment, the concentration of the herbicide active ingredient in these mixtures may be no more than about 2 wt %, no more than about 1 wt %, or no more than about 0.5 wt %.

In an embodiment, the herbicidal composition may be solid, wherein the herbicide active ingredient is incorporated into solid carriers such as clay, talc, pumice or bentonite.

### Methods of Use:

An aspect of the disclosure is a method of inhibiting plant growth, which comprises applying to the soil and/or to the plant a composition according to the present disclosure. In some embodiments, the composition comprises an effective amount of at least one herbicidally active ingredient according to the present disclosure, e.g., a compound of Formula A, B, A1, I, Ia, Ib, Ic or a compound as described in Table 2, including all the known stereoisomers.

The compositions may be applied in an amount sufficient to induce an herbicidal effect, which is in a herbicidally effective amount sufficient to inhibit plant growth or kill individual plants. For example, a composition prepared according to the present disclosure may be applied as an aqueous solution to plants including the plants' leaves, stems, branches, flowers, and/or fruit.

As shown in the examples, different preemergence and postemergence activities of the provided compounds of Formula A allow the control of the herbicidal activity. For example, L-menthyl succinate and nonanyl succinate monoesters gave a similar preemergence and early postemergence herbicidal activity, but a very different later postemergence herbicidal activity.

L-menthol, succinic acid and acetone/water had no effect on plant health compared to the untreated plant.

Both the succinate and 2-methylsuccinate monoesters of geraniol and nonanol gave a similarly potent later postemergence herbicidal activity to pelargonic acid after 1 day. Nonanol and geraniol both gave a lesser later postemergence herbicidal activity than their respective conjugates.

The succinate monoester of L-menthol was practically inert as a later postemergence herbicide against the target plants, similar to L-menthol. In contrast, the 2-methyl succinate monoester was a moderately potent later postemergence herbicide.

The succinate monoester of 2-phenylethanol was also a moderately potent later postemergence herbicide whereas the free alcohol was practically inert.

### EXAMPLES

### Example 1: Preparation of Monoesters of 2-methylsuccinic Acid

3-Methyldihydrofuran-2,5-dione (0.05 mol) and the corresponding alcohol (0.05 mol) were heated at 100 °C for 15 hours with stirring. The resultant mixture was cooled, diluted with diethyl ether (150 mL) and the product extracted from the organic phase with 0.25 M aqueous NaOH solution (4×50 mL). The combined aqueous phases were washed with diethyl ether (2×50 mL) and acidified with 2 M aqueous hydrochloric acid solution (30 mL). The product was extracted with diethyl ether (4×75 mL) and the combined organic portions rinsed with brine (50 mL), dried over anhydrous sodium sulphate, filtered and the solvent removed by distillation under reduced pressure to afford the title compound.

The obtained compounds were characterized by 1H-NMR and 13C-NMR. Spectroscopic data agreed with the proposed structure.

The following compounds were prepared:

### Nonanyl 2-Methylsuccinate Monoester Isomeric Mixture

### (2-methyl-4-(nonyloxy)-4-oxobutanoic acid and 3-methyl-4-(nonyloxy)-4-oxobutanoic acid)

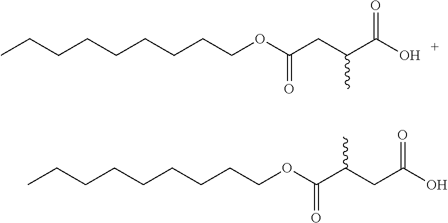

Approximately an equimolar mixture of regioisomers.

Yield: 89%; Retention factor (CH2Cl2/MeOH 95/5): 0.38; 1H-NMR (DMSO-d6; 400 MHz): 0.82-0.85 (m, 3H), 1.07-1.13 (m, 3H), 1.18-1.34 (m, 12H), 1.49-1.58 (m, 2H), 2.31-2.41 (m, 1H), 2.47-2.59 (m, 1H), 2.62-2.78 (m, 1H), 3.93-4.04 (m, 2H), 12.20 (br s, 1H). ¹³C-NMR (DMSO-d6, 100.6 MHz): 14.0 (CH₃), 16.8 (CH₃), 22.1 (CH₂), 25.3 and 25.3 (CH₂), 28.1 (CH₂), 28.7 (CH₂), 28.7 (CH₂), 28.9 (CH₂), 31.3 (CH₂), 35.2 and 35.3 (CH₂), 37.1 and 37.1 (CH), 63.9 and 63.9 (CH₂), 171.5 and 172.8 (CO), 174.8 and 176.2 (CO).

### Geranyl 2-Methylsuccinate Monoester Isomeric Mixture

((E)-4-((3,7-dimethylocta-2,6-dien-1-yl)oxy)-2-methyl-4-oxobutanoic acid and (E)-4-((3,7-dimethylocta-2,6-dien-1-yl)oxy)-3-methyl-4-oxobutanoic acid)

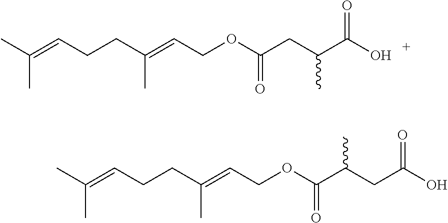

Approximately an equimolar mixture of regioisomers.

Yield: 80%; Retention factor (CH₂Cl₂/MeOH 95/5): 0.41; ¹H-NMR (DMSO-d6; 400 MHz): 1.08-1.22 (m, 3H), 1.56 (s, 3H), 1.64 (s, 3H), 1.65 (s, 3H), 1.96-2.09 (m, 4H), 2.31-2.42 (m, 1H), 2.48-2.60 (m, 1H), 2.63-2.78 (m, 1H), 4.46-4.58 (m, 2H), 5.03-5.09 (m, 1H), 5.24-5.30 (m, 1H), 12.18 (br s, 1H). ¹³C-NMR (DMSO-d6, 100.6 MHz): 16.2 (CH₃), 16.8 (CH₃), 17.6 (CH₃), 25.5 (CH₃), 25.8 (CH₂), 35.3 and 35.3 (CH), 37.0 and 37.1 (CH₂), 38.9 (CH₂), 60.6 and 60.7 (CH₂), 118.5 and 118.6 (CH), 123.7 (CH), 131.1 and 131.1 (C), 141.3 and 141.3 (C), 171.4 and 172.8 (CO), 174.8 and 176.2 (CO).

### L-Menthyl 2-Methylsuccinate Monoester Isomeric Mixture

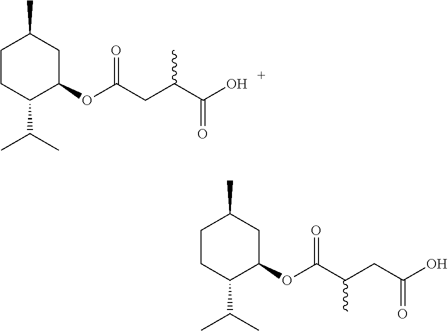

Approximately an equimolar mixture of regioisomers.

Yield: 74%; Retention factor (CH₂Cl₂/MeOH 95/5): 0.33; ¹H-NMR (DMSO-d6; 400 MHz): 0.66-0.75 (m, 3H), 0.81-0.90 (m, 7H), 0.90-1.00 (m, 1H), 1.00-1.07 (m, 1H), 1.06-1.13 (m, 3H), 1.29-1.50 (m, 2H), 1.58-1.69 (m, 2H), 1.78-1.92 (m, 2H), 2.27-2.41 (m, 1H), 2.41-2.58 (m, 1H), 2.63-2.76 (m, 1H), 4.50-4.62 (m, 1H). 13C-NMR (DMSO-d6, 100.6 MHz): 16.0-16.2-16.3 and 16.3 (CH₃), 16.8-16.9 and 16.9 (CH₃), 20.5-20.5-20.5 and 20.6 (CH₃), 21.9 and 21.9 (CH₃), 22.9-23.0 and 23.1 (CH₂), 25.7-25.7-25.7 and 25.8 (CH), 30.8 and 30.8 (CH), 33.7 and 33.8 (CH₂), 35.3 and 35.6 (CH), 37.1-37.3 and 37.4 (CH₂), 40.2-40.3-40.4 and 40.5 (CH₂), 46.3-46.4 and 46.4 (CH), 73.1-73.2-73.2 and 73.3 (CH), 171.0 and 171.0 (CO), 172.8 and 173.1 (CO), 174.4 and 174.4 (CO), 176.2 and 176.5 (CO).

### Example 2: Preemergence Herbicidal Activity-Seed Germination Inhibition

This example discloses the preemergence herbicidal activity in Petri dishes to assess the performance of the compounds of the disclosure on the seed germination inhibition.

Parallel experiments were set up in Petri dishes containing filter paper (diameter: 90 mm; particle retention: 12-16 μm). 3 mL of a stock solution of the compound of the disclosure was pipetted into each plate. Seeds were then added onto the paper filter (about 15 seeds of Lolium rigidum winmera and about 50 seeds of Amaranthus palmeri), and the Petri dishes were covered, sealed with parafilm and incubated for 8 to 10 days.

The procedure was slightly different for L. rigidum and A. palmeri seeds in terms of buffering and temperature. 50 mM sodium phosphate buffer pH 7 (including 0.5% Tween 20) was used with L. rigidum seeds while 50 mM Tris. HCl pH 7.5 (including 0.5% Tween 20) was the buffer of choice for testing A. palmeri seeds. Experiments involving L. rigidum seeds were set up at room temperature while A. palmeri seeds needed a constant temperature of 25 °C.

In all cases, negative and positive controls were set up. As negative control, distilled water and/or buffer containing 0.5% Tween 20 were used. As positive control for L. rigidum seeds, a solution of 6 mM racemic cis-PMD in distilled water containing 0.5% Tween 20 was used, while a solution of 3 mM eugenol in distilled water containing 0.5% Tween 20 was used for A. palmeri.

Succinate monoesters were tested in both distilled water and 50 mM buffer with 0.5% Tween 20 against L. rigidum. Results were similar in both cases.

The concentration of the active ingredient, expressed in mM, necessary for inhibiting the germination of 50% of the seeds obtained in buffer are shown in Table 3:

TABLE 3

| | L. rigidum | A. palmeri |
|---|---|---|
| Compound | (mM) | (mM) |
| L-menthyl succinate monoester | 6 | 6 |
| (racemic) cis-PMD succinate | 12 | 12 |
| monoester | | |
| (racemic) trans-PMD succinate | 12 | 12 |
| monoester | | |
| 2-phenethyl succinate monoester | 12 | 12 |
| 1-phenethyl succinate monoester | 12 | 6 |
| nonanyl succinate monoester | 6 | 6 |
| geranyl succinate monoester | 6 | 6 |
| L-menthyl 2-methylsuccinate | 12 | 12 |
| monoester | | |
| 1-nonanyl 2-methylsuccinate | 12 | — |
| monoester | | |
| geranyl 2-methylsuccinate | 6 | — |
| monoester | | |
| pelargonic acid (comparative) | 6 | — |

It was considered that a compound showed preemergence herbicidal activity towards L. rigidum when the percentage of germination was equal to or less than 50%, considering that negative control experiments usually led to 100% germination. However, when it came to A. palmeri, negative controls usually led to 40-50% germination so, in that case, it was considered that a compound showed preemergence herbicidal activity towards A. palmeri when the percentage of germination was equal to or less than 20%. Taking this into account, it was considered that the minimal concentration at which a compound showed herbicidal activity towards seeds was the minimal concentration at which the percentage of germination was 50% (or less) the percentage of germination of the negative control.

As can be seen in the Table 3, above, the tested succinate monoesters inhibit seed germination to a similar extent as pelargonic acid, which has the disadvantage of being volatile.

### Example 3: Early Postemergence Activity-Seedling Growth Inhibition

This example discloses the early postemergence activity in Petri dishes to assess the performance of the compounds of the disclosure on the seedling growth inhibition.

Early-seedlings from L. rigidum and A. palmeri were prepared using the procedures described in Example 1. Once the seeds started to germinate (2 days at 25 °C for A. palmeri and 4 days at room temperature for L. rigidum), they were moved to another plate containing filter paper pretreated with 3 mL of a 6 mM stock solution of L-menthyl succinate monoester or 1-nonanyl succinate monoester in 50 mM phosphate buffer pH 7 containing 0.5% v/v Tween 20. The plates were covered and sealed with parafilm and further incubated at room temperature (L. rigidum) or 25 °C (A. palmeri). A negative control was run in parallel in each case, containing 3 mL of the appropriate 50 mM buffer. Average changes in seedling length of treated seeds relative to the negative control were recorded in centimeters after one week of incubation.

The results are shown in Table 4:

TABLE 4

| | | | Average |
|---|---|---|---|
| | | | reduction |
| | | | in growth |
| | | Seedling | relative |
| | | length | to control |
| Seeds | Compound | (cm) | (%) |
| L. rigidum | L-menthyl succinate | 0.5-2 | 75 |
| L. rigidum | 1-nonanyl succinate | 1-3 | 60 |
| L. rigidum | Control (50 mM phosphate | >5 | — |
| | pH 7 containing 0.5% | | |
| | Tween 20) | | |
| A. palmeri | L-menthyl succinate | 2-4 | 33 |
| A. palmeri | 1-nonanyl succinate | 2-4 | 33 |
| A. palmeri | Control (50 mM Tris•HCl | 3-6 | — |
| | pH 6.5 containing 0.5% | | |
| | Tween 20) | | |

As can be seen in the Table 4, above, the tested succinate monoesters were active on the seedling growth inhibition as a proof of early postemergence activity.

### Example 4: Stability of L-Menthyl Succinate Monoester in Soil

This example discloses the assessment of the stability of L-menthyl succinate monoester in soil.

1 mL volumes of a 20 mM solution of L-menthyl succinate monoester prepared in 0.1M phosphate buffer pH 7.4 in D2O was applied to different quantities of agricultural soil (40, 80, 150, 250, 500 and 1000 mg) in triplicate, composed of 50% Bioland soil and 50% regular peat and the mixtures allowed to stand at room temperature. After 6, 27 and 144 hour time periods, samples were centrifuged (6,000 rpm for 10 mins) and the content of the herbicide was determined in the supernatant by 1H-NMR.

Table 5 shows the data obtained with this test:

TABLE 5

| Entry | Soil quantity (mg) | Time (h) | % Hydrolysis |
|---|---|---|---|
| 1 | 40 | 6 | 0 |
| 2 | 80 | 6 | 0 |
| 3 | 150 | 6 | 0 |
| 4 | 250 | 6 | 0 |
| 5 | 500 | 6 | 0 |
| 6 | 1000 | 6 | 0 |
| 7 | 40 | 27 | 0 |
| 8 | 80 | 27 | 0 |
| 9 | 150 | 27 | 0 |
| 10 | 250 | 27 | 0 |
| 11 | 500 | 27 | 0 |
| 12 | 1000 | 27 | 0 |
| 13 | 40 | 144 | 0 |
| 14 | 80 | 144 | 0 |
| 15 | 150 | 144 | <5 |
| 16 | 250 | 144 | <5 |
| 17 | 500 | 144 | <5 |
| 18 | 1000 | 144 | <5 |

As can be seen in Table 5 above, little hydrolysis of the monoester was observed over a 6 day period, with a small amount of L-menthol and succinic acid (<5%) beginning to be detected after this period.

### Example 5: Later Postemergence Activity

This example discloses the general procedure for the preparation and testing of formulations and their testing of later postemergence activity.

The following compositions were prepared:
a) Succinate monoester formulations:
   A 5% w/w suspension of succinate monoester, containing an equimolar quantity of L-menthol in a 5:4 mixture of acetone and water was prepared.
b) Pelargonic acid formulation:
   A 5% w/w suspension of pelargonic acid, containing an equimolar quantity of L-menthol in a 5:4 mixture of acetone and water was prepared.
c) Alcohol formulations:
   A 5% w/w solution of alcohol in a 5:4 mixture of acetone and water was prepared.
d) Succinic acid formulation:
   A 5% w/w solution of succinic acid in a 5:4 mixture of acetone and water was prepared.

To test the later postemergence activity, approximately 4 g of each solution was thoroughly shaken then sprayed onto parallel samples of different pre-grown plants selected from Wheatgrass, Pentas lanceolata, Viola x Witrockiala, Dactylis glomerata, and Chrysanthemum daisies, of similar size and appearance and differences in plant health were recorded over a 24 hour period relative to negative control (4 g of 5:4 acetone/water solution) and to untreated plant.

Table 6 shows the data obtained with this test, reporting the level of damage to the plant, wherein score “0” means “no effect”, and score “5” means “dead appearance”:

TABLE 6

| Compound | Score |
|---|---|
| L-menthyl succinate monoester | 1 |
| 2-phenethyl succinate monoester | 3 |
| nonanyl succinate monoester | 5 |
| geranyl succinate monoester | 5 |
| L-menthyl 2-methylsuccinate monoester | 3 |
| 1-nonanyl 2-methylsuccinate monoester | 4 |
| geranyl 2-methylsuccinate monoester | 5 |
| nonyl malonate monoester | 5 |
| nonyl glutarate monoester | 5 |
| pelargonic acid (comparative) | 5 |
| succinic acid (comparative) | 0 |
| L-menthol (comparative) | 0 |
| 2-phenylethanol (comparative) | 0 |
| 1-nonanol (comparative) | 3 |
| geraniol (comparative) | 2 |
| acetone/water (negative control) | 0 |

The post emergent effect of these compounds could not be expected until the data was gathered. Even upon analyzing the data, it is difficult to identify a trend to explain why one compound performed well and the others didn't. In other words, despite the similarity observed in preemergence herbicidal activity between the different compounds, it was surprising to see such a wide difference in their late-postemergence activity or to identify a trend to explain this effect.

For example, it is surprising that the succinate 2-methylsuccinate monoester of L-menthol would display lower activity than its succinate monoester, but a similar activity to 2-phenethyl succinate monoester. Also, it is surprising that the geranyl 2-methylsuccinate monoesters would display such a similar activity to pelargonic acid whereas nonanyl 2-methylsuccinate monoester does not.

The combination of the acid functionality of the succinate with different R groups appears to lead to unpredictable effects on later postemergence herbicidal activity but not preemergence activity.

L-menthol, succinic acid and acetone/water had no effect on plant health compared to the untreated plant.

Both the succinate and 2-methylsuccinate monoesters of geraniol and 1-nonanol gave a similarly potent later postemergence herbicidal activity to pelargonic acid after 1 day. 1-Nonanol and geraniol both gave a lesser herbicidal activity than their respective conjugates.

The succinate monoester of L-menthol was practically inert as a later postemergence herbicide, similar to L-menthol. In contrast, the 2-methyl succinate monoester was a moderately potent later postemergence herbicide.

The succinate monoester of 2-phenylethanol was also a moderately potent later postemergence herbicide whereas the free alcohol was practically inert.

### Example 6: Preemergence Activity in Soil

This example discloses the assessment of the preemergence activity in soil.

Seeds of L. rigidum were planted in a plastic seedbed. Each pot was 3.3 cm length×3.3 cm width×4 cm height. A mixture of 50% Bioland soil and 50% regular peat was used, and 3 cm of each pot was filled with this mixture. After that, around 20 seeds of L. rigidum were sowed in each pot and were covered with approximately 1 cm of soil. Finally, each pot was irrigated with 6 mL of a solution of 1.5-48 mM L-menthyl succinate monoester in either distilled water or 50 mM phosphate buffer. In all cases, Tween 20 was also added to the media: 0.5% v/v Tween 20 was used for 1.5-12 mM L-menthyl succinate monoester, but 8% v/v Tween 20 was needed for 24-48 mM L-menthyl succinate monoester due to solubility issues. The seedbed was incubated at room temperature for a week.

Negative controls were set up including: distilled water with 0.5% and 8% Tween 20, 50 mM phosphate buffer pH 7.0 with 0.5% and 8% Tween 20 and also tap water.

As solutions prepared in buffer and in water led to very similar results after 6 days, only results of solutions prepared in water (with 0.5-8% Tween 20) are shown in Table 7:

TABLE 7

| | | | | | Average |
|---|---|---|---|---|---|
| | Concentration | | Average | | reduction |
| | of L-menthyl | | reduction | | in length |
| | succinate | Number | in growth | Plant | relative |
| | monoester | of | to control | length | to control |
| Compound | (mM) | plants | (%) | (cm) | (%) |
| Control (tap water) | — | 19 | | 2 | |
| Control (distilled water | — | 20 | | 2 | |
| with 0.5% Tween) | | | | | |
| Control (distilled water | — | 17 | | 1.5 | |
| with 8% Tween) | | | | | |
| L-menthyl succinate | 1.5 | 18 | 10 | 1.25 | 38 |
| monoester | | | | | |
| L-menthyl succinate | 3 | 10 | 50 | 0.5 | 75 |
| monoester | | | | | |
| L-menthyl succinate | 6 | 1 | 95 | 0.8 | 60 |
| monoester | | | | | |
| L-menthyl succinate | 12 | 0 | 100 | 0 | 100 |
| monoester | | | | | |
| L-menthyl succinate | 24 | 0 | 100 | 0 | 100 |
| monoester | | | | | |
| L-menthyl succinate | 48 | 0 | 100 | 0 | 100 |
| monoester | | | | | |

As can be seen in Table 7 above, the preemergence activity of L-menthyl succinate monoester in soil is remarkable, inhibiting completely the growth of the plant or reducing the plant length, in cases where the inhibition of the growth is not complete.

### Example 7: Postemergence Activity in Greenhouse

L-menthyl succinic acid monoester solution: Six concentrates of different concentration were prepared by suspending L-menthyl succinic acid monoester in water containing 0.5% w/w Tween20 and neutralized with sodium hydroxide to provide clear colorless solutions with final concentrations of 40, 80, 160, 200, 320 and 400 g per liter.

Nonanyl succinic acid monoester solution: Four concentrates of different concentration were prepared by suspending nonanyl succinic acid monoester in a 1:1 mixture of ethanol and water to provide clear colorless solutions with final concentrations of 30, 33.3, 40 and 45 g per liter.

Ten seeds from one broadleaf (Amaranthus palmeri) and one narrowleaf (Lolium multiflorum) weed species were sown into 7×7×10 cm pots containing 75% agricultural soil 25% peat. After 1-2 weeks, seedlings were thinned to 4 per pot and grown in greenhouse, without additional light or control temperature. Temperatures ranged from 15 to 35 °C. At the growth stage of 2-3 leaves for grasses or 3-4 leaves for dicots the two compounds were applied at rates shown in Table 8 following further dilution with water using a precision bench sprayer, with two flat fan nozzles delivering 200 l/ha at 2 KPa of pressure, standard field conditions and results are reported one month post-treatment. Five repetitions were conducted per treatment.

TABLE 8

| | | Active | | |
|---|---|---|---|---|
| | | ingredient | | |
| | | application | Volume | % kill |
| | | rate | applied | relative to |
| | Plant | (kg/ | (L/ | untreated |
| Compound | species | hectare) | hectare) | plants |
| L-menthyl succinate | Amaranthus | 8 | 200 | 40 ± 6 |
| monoester | palmeri | | | |
| L-menthyl succinate | Amaranthus | 16 | 200 | 89 ± 5 |
| monoester | palmeri | | | |
| L-menthyl succinate | Amaranthus | 32 | 200 | 100 ± 0 |
| monoester | palmeri | | | |
| L-menthyl succinate | Amaranthus | 40 | 200 | 98 ± 1 |
| monoester | palmeri | | | |
| L-menthyl succinate | Amaranthus | 64 | 200 | 99.6 ± 1 |
| monoester | palmeri | | | |
| L-menthyl succinate | Amaranthus | 80 | 200 | 100 ± 0 |
| monoester | palmeri | | | |
| L-menthyl succinate | Lolium | 8 | 200 | 0 ± 0 |
| monoester | multiflorum | | | |
| L-menthyl succinate | Lolium | 16 | 200 | 0 ± 0 |
| monoester | multiflorum | | | |
| L-menthyl succinate | Lolium | 32 | 200 | 0 ± 0 |
| monoester | multiflorum | | | |
| L-menthyl succinate | Lolium | 40 | 200 | 20 ± 12 |
| monoester | multiflorum | | | |
| L-menthyl succinate | Lolium | 64 | 200 | 63 ± 15 |
| monoester | multiflorum | | | |
| L-menthyl succinate | Lolium | 80 | 200 | 84 ± 2 |
| monoester | multiflorum | | | |
| Nonanyl succinate | Amaranthus | 8 | 200 | 96 ± 2 |
| monoester | palmeri | | | |
| Nonanyl succinate | Amaranthus | 12 | 400 | 100 ± 0 |
| monoester | palmeri | | | |
| Nonanyl succinate | Amaranthus | 18 | 400 | 100 ± 0 |
| monoester | palmeri | | | |
| Nonanyl succinate | Amaranthus | 20 | 600 | 100 ± 0 |
| monoester | palmeri | | | |
| Nonanyl succinate | Amaranthus | 24 | 600 | 100 ± 0 |
| monoester | palmeri | | | |
| Nonanyl succinate | Amaranthus | 32 | 800 | 100 ± 0 |
| monoester | palmeri | | | |
| Nonanyl succinate | Lolium | 8 | 200 | 1 ± 1 |
| monoester | multiflorum | | | |
| Nonanyl succinate | Lolium | 12 | 400 | 12 ± 5 |
| monoester | multiflorum | | | |
| Nonanyl succinate | Lolium | 18 | 400 | 30 ± 3 |
| monoester | multiflorum | | | |
| Nonanyl succinate | Lolium | 20 | 600 | 58 ± 5 |
| monoester | multiflorum | | | |
| Nonanyl succinate | Lolium | 24 | 600 | 50 ± 3 |
| monoester | multiflorum | | | |
| Nonanyl succinate | Lolium | 32 | 800 | 93 ± 3 |
| monoester | multiflorum | | | |
| Glyphosate* | Amaranthus | 0.54 | 1.5 | 100 ± 0 |
| | palmeri | | | |
| Glyphosate* | Amaranthus | 3 | 1.1 | 100 ± 0 |
| | palmeri | | | |
| Glyphosate* | Lolium | 0.54 | 1.5 | 100 ± 0 |
| | multiflorum | | | |
| Glyphosate* | Lolium | 3 | 1.1 | 100 ± 0 |
| | multiflorum | | | |
| Pelargonic acid* | Amaranthus | 8 | 200 | 92 ± 4 |
| | palmeri | | | |
| Pelargonic acid* | Amaranthus | 16 | 200 | 100 ± 0 |
| | palmeri | | | |
| Pelargonic acid* | Lolium | 8 | 200 | 13 ± 3 |
| | multiflorum | | | |
| Pelargonic acid* | Lolium | 16 | 200 | 50 ± 17 |
| | multiflorum | | | |

*Commercial concentrates: ROUNDUP ULTRA PLUS (containing 36% Glyphosate); KALINA BIOHERBICIDA (containing 68% Pelargonic acid). Negative controls using adjuvant only gave no increase in mortality relative to untreated plants.

As shown above, a formulation of nonanyl succinate monoester gave a more potent postemergence herbicidal effect than L-menthyl succinate monoester and a comparable effect to a commercial formulation of Pelargonic acid.

The herbicidal effect of both monosuccinate esters and pelargonic acid was more pronounced toward the broadleaf weed (A. palmeri) than the narrowleaf weed (L. multiflorum). The succinate esters described herein may provide better selectivity than existing natural herbicides such as pelargonic acid.

Glyphosate gave a considerably higher activity than succinate monoesters and Pelargonic acid. However, many strains of A. palmeri have become resistant to glyphosate, requiring much higher application rates, up to 3.2 kg per hectare.

Although various embodiments have been shown and described, the disclosure is not limited to such embodiments and will be understood to include all modifications and variations as would be apparent to one of ordinary skill in the art. Therefore, it should be understood that the disclosure is not intended to be limited to the particular forms disclosed; rather, the intention is to cover all modifications, equivalents, and alternatives falling within the spirit and scope of the disclosure as defined by the appended claims.

What is claimed is:

1. An herbicide composition for inhibiting plant growth, comprising an herbicidally active ingredient of Formula I: 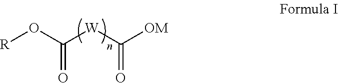
wherein:
n is 0-4;
M is H or a cation;
R is a monoterpenoid or a C2-C14 hydrocarbon; and
when n is 1 or greater, each Wis independently selected from CH, CH₂, CHR¹, or CR¹R², wherein
R¹ and R² are each independently selected from a C1-C3 alkyl, benzyl, phenyl, hydroxyl, or aminyl.

2. The composition according to claim 1, wherein R is a monoterpenoid selected from L-menthyl, D-menthyl, isopulegyl, α-terpinyl, geranyl, citronellyl, para-menth-3-ol-8-yl (PMD-8-yl), para-menth-8-ol-3-yl (PMD-3-yl), linalyl, perillyl, bornyl, or stereoisomers thereof.

3. The composition according claim 1, wherein R is selected from 2-phenethyl, 1-phenethyl, L-menthyl, D-menthyl, D-(+)-para-menth-8-ol-3-yl, L-(−)-para-menth-8-ol-3-yl, isopulegyl, α-terpinyl, geranyl, nonanyl, heptyl, undecanyl, and citronellyl.

4. The composition according to claim 1, wherein the herbicidally active ingredient is selected from menthyl succinate monoester, menthyl 2-methylsuccinate monoester, menthyl 3-methylsuccinate monoester, 2-phenethyl succinate monoester, 1-phenethyl succinate monoester, geranyl 2-methylsuccinate monoester, geranyl 3-methylsuccinate monoester, geranyl succinate monoester, nonanyl succinate monoester, nonanyl 2-methylsuccinate monoester, D-menthyl succinate monoester, D-(+)-para-menth-3-ol-8-yl succinate monoester, L-(−)-para-menth-3-ol-8-yl succinate monoester, D-(+)-para-menth-8-ol-3-yl succinate monoester, L-(−)-para-menth-8-3-yl succinate monoester, isopulegyl succinate monoester, 1-phenethyl succinate monoester, alfa-terpineol succinate monoester, heptyl succinate monoester, n-undecanyl succinate monoester, citronellyl succinate monoester, geranyl oxalate monoester, geranyl malonate monoester, geranyl glutarate monoester, isomers thereof, or stereoisomers thereof.

5. The composition according to claim 1, wherein the herbicidally active ingredient is L-menthyl succinate monoester; and
wherein the composition exhibits selective preemergence and early postemergence herbicidal activity; or
wherein the composition exhibits selective activity against dicots over monocots.

6. The composition according to claim 1, wherein the herbicidally active ingredient is selected from 1-nonanyl succinate monoester and geranyl succinate monoester;
wherein the composition exhibits non-selective preemergence and postemergence herbicidal activity; or
wherein the composition exhibits selective activity against dicots over monocots.

7. The composition according to claim 1, wherein the herbicidally active ingredient is selected from L-menthyl 2-methylsuccinate monoester, 1-nonanyl 2-methylsuccinate monoester, and geranyl 2-methylsuccinate monoester.

8. The composition according to claim 1, wherein the composition is in a form selected from a solution, a soluble powder, an emulsifiable concentrate, a wettable powder, a liquid flowable, a dry flowable, water-dispersible granules, granules, or pellets.

9. The composition according to claim 1, wherein the composition is an emulsifiable concentrate composition.

10. The composition according to claim 9, wherein the emulsifiable concentrate composition further comprises at least one surfactant, and a water immiscible solvent.

11. The composition according to claim 10, wherein the content of the herbicidally active ingredient is between 20 wt % and 70 wt %.

12. The composition according to claim 1, further comprising a component selected from humectants, viscosity adjusting ingredients, pH adjusting ingredients, buffers, antifreeze agents, antifoam agents, fillers, binders, dispersants, preservatives, biocides, acid scavengers, hydrotropes, densifiers, nitrogen fertilizer, storage stabilizers, or mixtures thereof.

13. The composition of claim 1, wherein the composition does not comprise additional herbicidally active ingredients.

14. The composition of claim 1, wherein R is an unsubstituted C6-C12 cyclic hydrocarbon.

15. A method of inhibiting plant growth, the method comprising applying an effective amount the composition of claim 1 to soil and/or to a plant.

16. The method of claim 15, wherein the herbicidally active ingredient is L-menthyl succinate monoester; and
wherein the method comprises applying the composition to soil comprising seeds of the genus Lolium to inhibit growth of the same.

17. The method of claim 15, wherein the herbicidally active ingredient is a succinate monoester;
wherein the method comprises applying the composition to mature plants of the genus Lolium and mature plants of the genus Amaranthus; and
wherein applying the composition inhibits growth of the mature plants of the genus Amaranthus by a first amount and inhibits growth of the mature plants of the genus Lolium by a second amount that is less than the first amount.

18. The method of claim 15, wherein the content of the herbicidally active ingredient is between 20 wt % and 70 wt %.

19. The method of claim 18, wherein the composition does not comprise additional herbicidally active ingredients.

20. The method of claim 15, wherein R is an unsubstituted C6-C12 cyclic hydrocarbon.
